(19) United States
(12) Patent Application Publication
(10) Pub. No.: US 2008/0213570 A1
(43) Pub. Date: Sep. 4, 2008

(54) SELF-ASSEMBLED CONDUCTIVE DEFORMABLE FILMS

(76) Inventors: Jennifer Hoyt Lalli, Blacksburg, VA (US); Richard Otto Claus, Eggelston, VA (US); Victor Vincent Baranauskas, Christiansburg, VA (US); Lacy Maxwell Bush, Christiansburg, VA (US)

Correspondence Address: SHERR & NOURSE, PLLC, 620 HERNDON PARKWAY, SUITE 200, HERNDON, VA, 20170, US

(21) Appl. No.: 12/033,889

(22) Filed: Feb. 19, 2008

Related U.S. Application Data
(60) Provisional application No. 60/890,297, filed on Feb. 16, 2007.

(51) Int. Cl. B32B 5/16; B32B 27/06; B32B 27/40; B32B 27/36

(52) U.S. Cl. 428/328; 428/411.1; 428/480; 428/423.1

(57) ABSTRACT

An apparatus (and a method of making the apparatus) that includes a flexible base material and a flexible conductive material formed on the flexible base material. Both the flexible base material and the flexible conductive material have shrinkable and/or stretchable properties. The flexible base material may include a shrinkable polymer (e.g. PVC/PET or “shrink wrap”), which may shrink up to 500%. The flexible base material may include a stretchable polymer (e.g. Mylar), which may be stretched by at least 1000%. These stretchable and shrinkable properties may be exhibited without substantial functional degradation of either the flexible base material and/or the flexible conductive material.

The present application claims priority to U.S. Provisional Patent Application No. 60/890,297 (filed Feb. 16, 2007), which is hereby incorporated by reference in its entirety.

### BACKGROUND

Conductive materials (e.g. gold, copper, silver, etc.) are used in many technological applications. For example metals are used as wires to transmit electricity. In similar examples, sheets of metal are used to transfer heat, protect against electromagnetic radiation (e.g. radio waves), antennas, and many other applications. However, conductive materials have traditionally been in the form of a bulk metal (e.g. a piece of gold or copper) that is purified and formed in a specific shape based on the application. These traditional conductive materials cannot be stretched, shrunk, or have flexible properties. Accordingly, traditional conductive materials have limited applications based on their natural rigid form and composition.

### SUMMARY

Embodiments relate to an apparatus (and a method of making the apparatus) that includes a flexible base material and a flexible conductive material formed on the flexible base material. Both the flexible base material and the flexible conductive material have shrinkable and/or stretchable properties. The flexible base material may include a shrinkable polymer (e.g. PVC/PET or “shrink wrap”), which may shrink up to 500%. The flexible base material may include a stretchable polymer (e.g. Mylar), which may be stretched by at least 1000%. These stretchable and shrinkable properties may be exhibited without substantial functional degradation of either the flexible base material and/or the flexible conductive material.

Unlike traditional conductive materials (e.g. bulk metal), an apparatus including a flexible base material and a flexible conductive material may have many unique applications. For example, such flexible materials may be use in sensors, packaging, wiring enclosures, lightning strike protection films, textiles, flexible electromagnetic shields, building insulation materials, magnetic recording tapes, loudspeakers, capacitors, and advanced aircrafts. These examples applications may be impossible, impractical, and/or inefficient with traditional conductive materials.

The flexible conductive material may include at least one nano-particle layer (e.g. including gold nano-clusters) and at least one linking agent layer. The at least one nano-particle layer is bonded to the at least one linking agent layer (e.g. through electrostatic and/or covalent bonding). In embodiments, by shrinking the flexible base material the at least one nano-particle layer and the at least one linking agent layer may be formed more efficiently and/or increase the conductivity.

### DRAWINGS

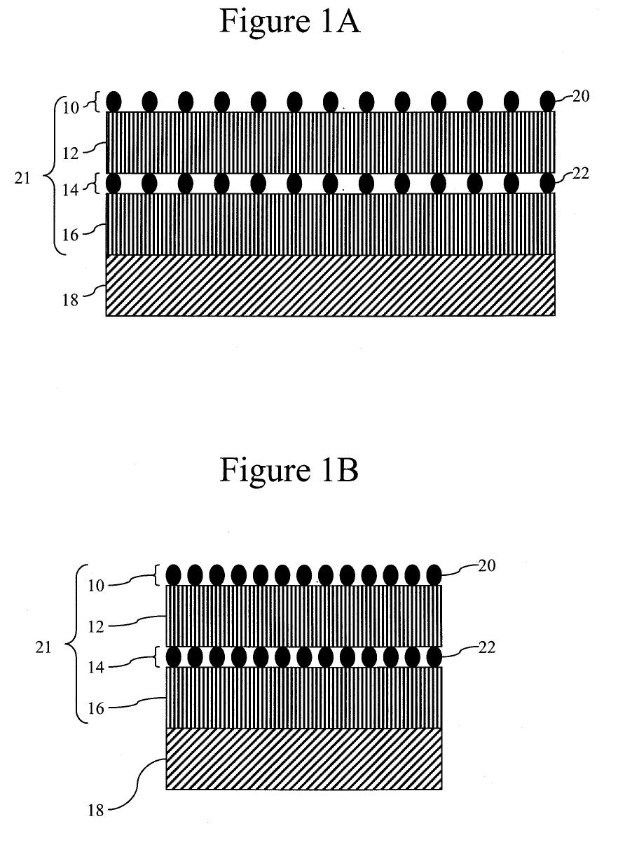

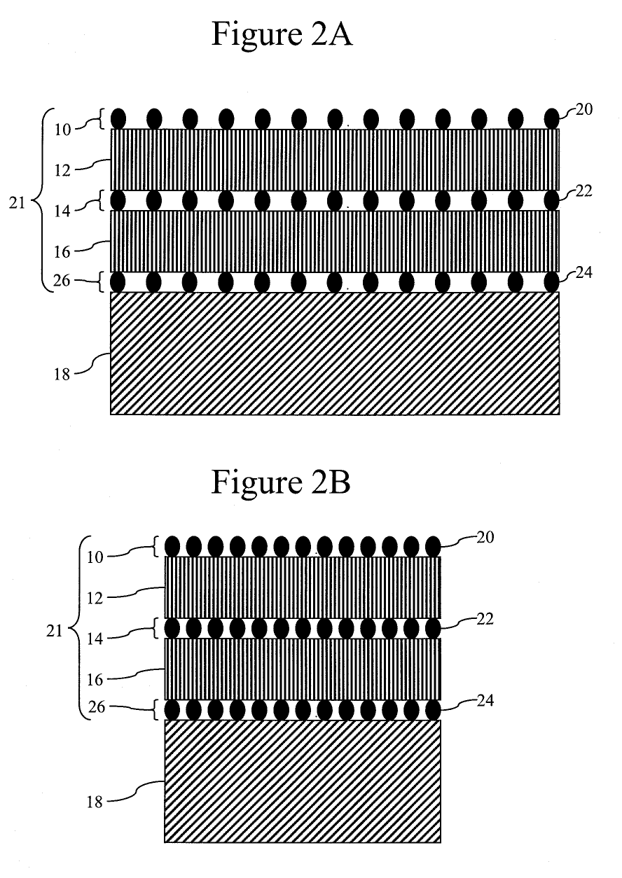

Example FIGS. 1A, 1B, 2A, and 2B illustrate a flexible conductive material formed on a flexible base material that have shrinkable properties, in accordance with embodiments.

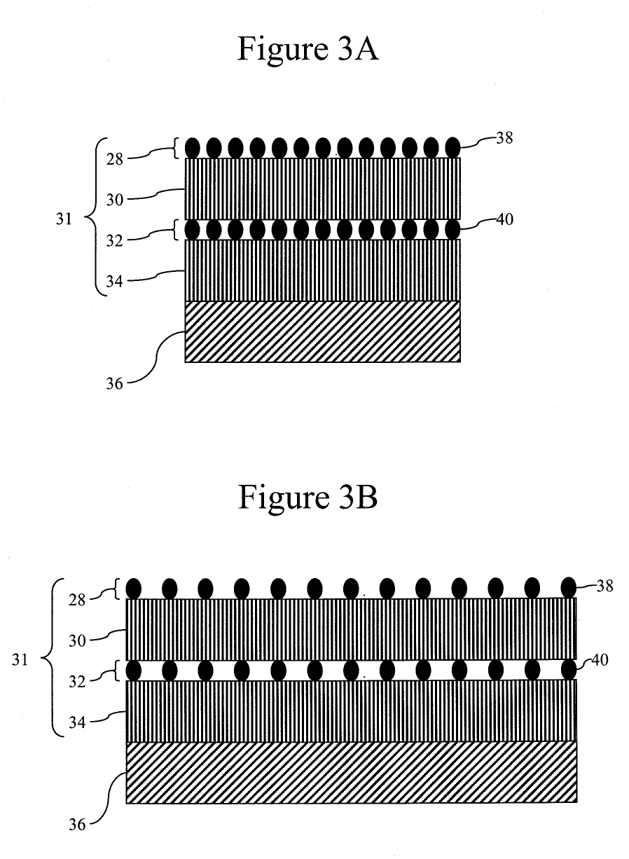

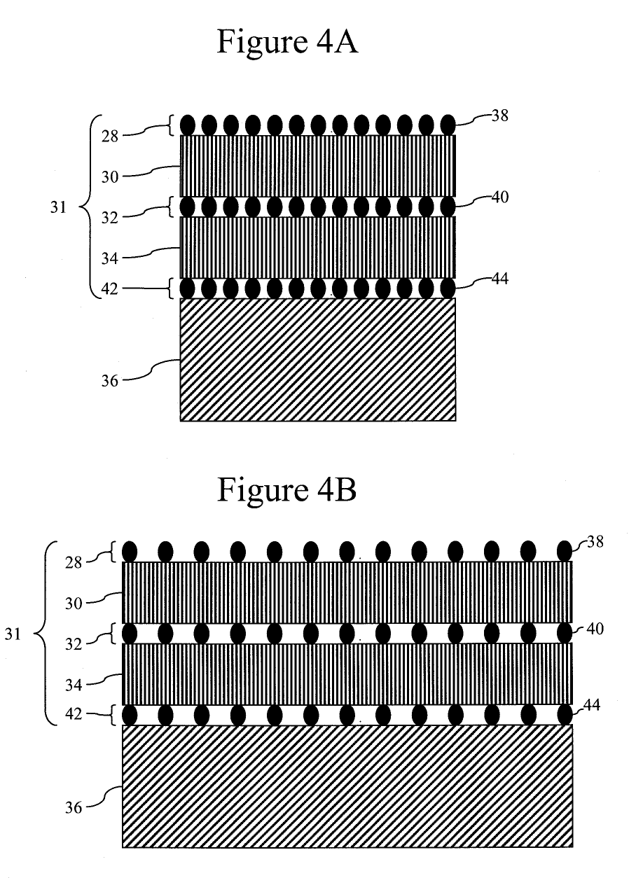

Example FIGS. 3A, 3B, 4A, and 4B illustrate a flexible conductive material formed on a flexible base material that have stretchable properties, in accordance with embodiments.

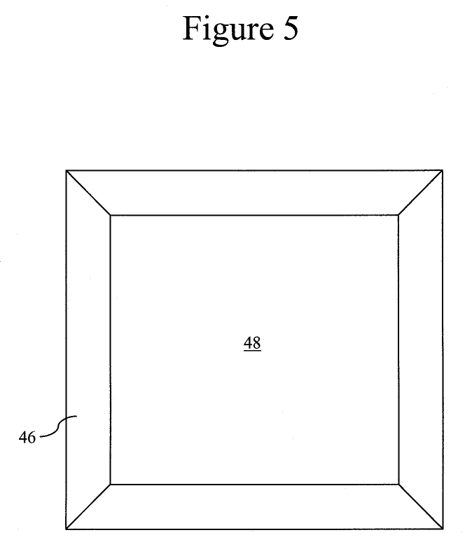

Example FIG. 5 illustrates a frame that holds a flexible base material as a flexible conductive material is formed on the flexible base material, in accordance with embodiments.

### DESCRIPTION

Example FIGS. 1A and 1B illustrate a flexible base material 18 with a flexible conductive material 21 formed on the flexible base material 18 that have shrinkable properties. Flexible conductive material 21 includes nano-size conductive particles 20, 22 that do not substantially deteriorate due to shrinking of flexible base material 18, in accordance with embodiments.

FIG. 1A illustrates first linking agent material layer 16 (of flexible conductive material 21) bonded to flexible base material 18. First linking agent material layer 16 may be also bonded to first nano-particle material layer 14. First nano-particle material layer 14 may be also bonded to second linking agent material layer 12. Second linking agent material layer 12 may be also bonded to second nano-particle material layer 10. Although only two linking agent layers (i.e. first linking agent material layer 16 and second linking agent material layer 12) and two nano-particle material layers (i.e. first nano-particle material layer 14 and second nano-particle material layer 10) are illustrated, embodiments may include any number of linking agent material layers and nano-particle material layers (including just one nano-particle material layer and/or linking agent material layer).

In embodiments, the flexible conductive material 21 may be formed directly on the flexible base material 18. The flexible base material 21 may be substantially free standing, in embodiments. In embodiments, the flexible base material 18 may be supported by a rigid substrate and then removed from the rigid substrate after formation of the flexible conductive material 21 (e.g. as a decal). In embodiments, the flexible base material 18 may be supported by a support structure (e.g. a frame, as illustrated in FIG. 5) during formation of the flexible conductive material 21. By forming a flexible conductive material on a flexible base material, fabrication and processing efficiency may be optimized.

First nano-particle material layer 14 includes nanoparticles 22. In embodiments, nano-particles 22 may be conductive nano-particles (e.g. nano-size gold clusters). Nano-particles 22 may be individually bonded to first linking agent material layer 16. Bonding of nano-particles 22 to first linking agent material layer 16 may be either electrostatic bonding and/or covalent bonding. Nano-particles 22 may not be substantially bonded to each other. Accordingly, as first linking agent material layer 16 expands or contracts, the bond between the nano-particles 22 and first linking agent material layer 16 is not significantly compromised.

As illustrated in example FIG. 1B, an apparatus including flexible base material 18 and flexible conductive material 21 may be shrunk. When shrunk, nano-particles 22 remain bonded to first linking material layer 16 as it is shrunk with the flexible base material 18. Since nano-particles 22 of first nano-particle material layer 14 are not bonded to each other, shrinking of first linking material layer 16 does not significantly compromise the robustness of first nano-particle material layer 14.

Although nano-particles 22 in first nano-particle material layer 14 are not bonded to each other, nano-particles 22 may be arranged close enough to each other, such that they may be electrically coupled to each other. In other words, in embodiments, electrical current may flow between adjacent nano-particles 22 in first nano-particle material layer 14. In fact, in embodiments, the rate of electrical conduction (i.e. electrical resistance) in first nano-particle material layer 14 (e.g. including gold nano-clusters) may be comparable and/or exceed that of solid gold (due to lattice inefficiencies in solid gold). Shrinking of first linking material layer 16 may increase the resistance of first nano-particle material layer 14 (due to a decrease in distance between neighboring nano-particles 22).

Accordingly, by shrinking base material layer 18, conductivity of the nano-particle layers may be increased. Shrinking of the base material layer may be an effective way to increase the conductivity of the material, by minimizing the number of nano-particle material layers and linking material layers that would otherwise need to be deposited to achieve the same level of conductivity. In embodiments, shrinking may be an effective means of increasing the conductivity of the material beyond a level that can be achieved by forming any number of layers of nano-particle material layer and linking material layers. In embodiments, shrinking of the base material layer 18 may be an effective way to conform the conductive material layer to a host structure (e.g. an airplane wing). For example, a preshrunk flexible base material and flexible conductive material may be placed on a host structure and then shrunk to fit the host structure. Shrinking may be accomplished by mechanical, electrical, thermal, and/or light stimulus.

Second linking agent material layer 12 may also be bonded to first nano-particle material layer 14, with the same or similar bonding mechanism as the bonding between first nano-particle material layer 14 and first linking agent material layer 16, in accordance with embodiments. In embodiments, first linking agent material layer 16 and second linking agent material layer 12 may include the same material and/or configuration. In embodiments, first linking agent material layer 16 and second linking agent material layer 12 may include different materials and/or configurations.

Second nano-particle material layer 10 may be bonded to second linking agent material layer 12 with the same or similar bonding mechanism as the bonding between first nano-particle material layer 14 and first linking agent layer 16. Additional linking agent material layer(s) and/or nano-particle material layer(s) may be formed over second nano-particle material layer 10, in accordance with embodiments. In embodiments, first nano-particle material layer 14 and second nano-particle material layer 10 may include the same material (i.e. nano-particles 20 and nano-particles 22 may be the same type of nano-particles) and/or configuration. In embodiments, first nano-particle material layer 14 and second nano-particle material layer 10 may include different materials (i.e. nano-particles 20 and nano-particles 22 may be different types of nano-particles) and/or configurations.

As illustrated in example FIGS. 2A and 2B, a nano-particle material layer (e.g. third nano-particle material layer 26 with nano-particles 24) may be formed between first linking agent layer 16 and flexible base material 18. In other words, in embodiments, a flexible base material may be bonded directly with a nano-particle material layer (e.g. third nano-particle material layer 26) or indirectly through a linking agent layer (e.g. first linking agent layer 18).

In embodiments, a flexible base material and linking agent material layer(s) may have the same, similar, and/or compatible elastic properties. In other words, when flexible base material is deformed through stress, straining, or shrinking, the elasticity of linking agent material layer(s) may not prevent a flexible base material from deforming since it is elastically compatible with the flexible base material. Since nano-particle material layer(s) include individual nano-particles that are independently bonding to an adjacent flexible base material and/or linking agent material layer(s), nano-particle material layer(s) may not prevent a flexible base material from deforming, in accordance with embodiments. Further, during deformation of a flexible base material, nano-particle material layers may not be subjected to significant mechanical strain, since there is substantially no bonding between adjacent nano-particles in the nano-particle material layer(s), in accordance with embodiments.

Nano-particles (e.g. nano-particles 20, nano-particles 22, and/or nano-particles 24) may be formed through a self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials.

Through self assembly, nano-particles may be substantially uniformally and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a flexible base material). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thickness that is approximately the diameter of the individual nano-particles. Through a self-assembly deposition method, nano-particles that do not bond to a host layer may be removed, so that a nano-particles material layer is formed that is relatively uniform in thickness and material distribution.

Linking agent material layer(s) (e.g. first linking agent material layer 16 and/or second linking agent material layer 12) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, and/or other similar materials. Linking agent material layer(s) may include materials that are polarized, in order for bonding with nano-particles, in accordance with embodiments.

In embodiments, linking agent material layer(s) may include a flexible material, an elastic material, and/or an elastomeric polymer. Accordingly, when nano-particles are bonded to sites of material in a linking agent material layer, then the nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is shrunk, stretched, strained, and/or deformed, bonded nano-particles will move with sites of the linking agent material layer to which they are bonded, thus avoiding any disassociation of the nano-particles from their host during deformation.

In embodiments, flexible base material 18 may include a shrinkable material. For example, flexible base material 18 may include a shrinkable polymer. An example of a shrinkable polymer is polyvinyl chloride polyethylene terephthalate (e.g. PVC/PET or “shrink wrap”) or a material with similar properties. In embodiments, flexible conductive material 18 may first be formed on a shrinkable flexible base material 18 (e.g. FIGS. 1A and 2A) and then after formation of the flexible conductive material 18 be shrunk (e.g. FIGS. 1B and 2B). As shown in FIGS. 1B and 2B, nanoparticles 20, 22, and/or 24 become closer together after shrinking (compared to the distances between adjacent nanoparticles in FIGS. 1A and 2A). In embodiments, when the nanoparticles become closer together due to shrinking, the electrical interaction between adjacent nanoparticles increases, thus increasing conductivity. Accordingly, shrinking of the flexible base material may be an effective and/or efficient means to increase the conductivity of the flexible conductive layer.

Note that the thicknesses in FIGS. 1A, 1B, 2A, 2B, 3A, 4B are shown for illustration and are not drawn to scale. In embodiments, the thickness of the flexible conductive layer is significantly less than the thickness of the flexible base material. Accordingly, since the material in the flexible base material and the flexible conductive material are elastically compatible, deformation, shrinking, and/or stretching of the flexible base material cause the flexible conductive material to comply with the flexible base material by deforming shrinking, and/or stretching.

In embodiments illustrated in FIGS. 1A, 1B, 2A, and 2B, the flexible base material 18 may be shrunk either irreversibly or reversibly. In embodiments, after flexible base material is shrunk, the flexible base material may still maintain flexible properties and have the ability to be further shrunk, stretched, and/or otherwise deformed. Example FIGS. 3A, 3B, 4A, and 4B illustrate stretching and/or deformation of flexible base material 36. In embodiments, flexible base material 36 may be the same as flexible base material 18 in either its pre-shrunk form or post-shrunk form.

In embodiments illustrated in FIGS. 3A, 3B, 4A, and 4B, flexible base material 36 may have stretchable properties. For example, the stretchable properties may allow flexible base material 36 to be stretched and/or strained by at least 1000% by mechanical, electrical, thermal, and/or light stimulus. In embodiments, a stretchable flexible base material (e.g. flexible base material 36) may include biaxially oriented polyethylene terephthalate material (e.g. Mylar) or a material with similar properties. In embodiments, flexible base material 36 may include a shape memory polymer.

FIG. 3A illustrates to first linking agent material layer 34 (of flexible conductive material 31) bonded to flexible base material 36. First linking agent material layer 34 may be also bonded to first nano-particle material layer 32. First nano-particle material layer 32 may be also bonded to second linking agent material layer 30. Second linking agent material layer 30 may be also bonded to second nano-particle material layer 28. Although only two linking agent layers (i.e. first linking agent material layer 34 and second linking agent material layer 30) and two nano-particle material layers (i.e. first nano-particle material layer 32 and second nano-particle material layer 28) are illustrated, embodiments may include any number of linking agent material layers and nano-particle material layers (including just one nano-particle material layer and/or linking agent material layer).

First nano-particle material layer 32 includes nanoparticles 40. In embodiments, nano-particles 40 may be conductive nano-particles (e.g. nano-size gold clusters). Nano-particles 40 may be individually bonded to first linking agent material layer 34. Bonding of nano-particles 40 to first linking agent material layer 34 may be either electrostatic bonding and/or covalent bonding. Nano-particles 40 may not be substantially bonded to each other. Accordingly, as first linking agent material layer 34 expands or contracts, the bond between the nano-particles 40 and first linking agent material layer 34 is not significantly compromised.

Although nano-particles 40 in first nano-particle material layer 32 are not bonded to each other, nano-particles 40 may be arranged close enough to each other, such that they may be electrically coupled to each other. In other words, in embodiments, electrical current may flow between adjacent nano-particles 40 in first nano-particle material layer 32. In fact, in embodiments, the rate of electrical conduction (i.e. electrical resistance) in first nano-particle material layer 32 (e.g. including gold nano-clusters) may be comparable and/or exceed that of solid gold (due to lattice inefficiencies in solid gold). Stretching of first linking material layer 34 with flexible base material 36 (shown in FIG. 3A) may decrease the resistance of first nano-particle material layer 32 (due to an increase in distance between neighboring nano-particles 40). In embodiments, this decrease in resistance may have unique applications, such as sensors (e.g. strain sensors, temperature sensors, pressure sensors, and other types of sensors).

Second linking agent material layer 30 may also be bonded to first nano-particle material layer 32, with the same or similar bonding mechanism as the bonding between first nano-particle material layer 32 and first linking agent material layer 34, in accordance with embodiments. In embodiments, first linking agent material layer 34 and second linking agent material layer 30 may include the same material and/or configuration. In embodiments, first linking agent material layer 34 and second linking agent material layer 30 may include different materials and/or configurations.

Second nano-particle material layer 28 may be bonded to second linking agent material layer 30 with the same or similar bonding mechanism as the bonding between first nano-particle material layer 32 and first linking agent layer 34. Additional linking agent material layer(s) and/or nano-particle material layer(s) may be formed over second nano-particle material layer 28, in accordance with embodiments. In embodiments, first nano-particle material layer 32 and second nano-particle material layer 28 may include the same material (i.e. nano-particles 38 and nano-particles 40 may be the same type of nano-particles) and/or configuration. In embodiments, first nano-particle material layer 32 and second nano-particle material layer 28 may include different materials (i.e. nano-particles 38 and nano-particles 40 may be different types of nano-particles) and/or configurations.

As illustrated in example FIGS. 4A and 4B, a nano-particle material layer (e.g. third nano-particle material layer 42 with nano-particles 44) may be formed between first linking agent layer 34 and flexible base material 36. In other words, in embodiments, a flexible base material may be bonded directly with a nano-particle material layer (e.g. third nano-particle material layer 42) or indirectly through a linking agent layer (e.g. first linking agent layer 36).

Example FIG. 5 illustrates a frame 46 holding flexible base material 48, in accordance with embodiments. During formation of a flexible conductive material on flexible base material 48, a frame may maintain the flexible base material in a flat configuration to assist in deposition of the flexible conductive material. Other support mechanisms (besides frame 36) may be utilized to assist in deposition of a flexible conductive material, in accordance with embodiments.

In embodiments, a flexible base material may include PET, PVC/PET, polyurethane, polysiloxane, a poly(urethane-soloxane) copolymer, poly(vinyl chloride), polyisoprene-cis, polyisobutylene, polybutadiene, styrene butadiene copolymers (SBR), nitrile rubber, an acrylonitrile-butadiene random copolymer, butyl rubber, an isoprene-isobutylene copolymer, an acrylonitrile-butadiene-styrene copolymer, polychloroprene, and/or poly(ethylene-stat-propylene). Other materials with similar properties may also be included, in accordance with embodiments.

Embodiments may be implemented in a wide range of applications, including, but not limited to highly conductive sensors (strain, pressure, chemical, temperature, etc.) protective packaging for electronics or electronic wiring enclosures, lightning strike protection films and textiles as laminates within composites, covering over paper, photographs, clothing or shelter vehicle textiles, clear protective overlays from the environment to prevent deterioration of sensitive documents; or conductive overlays where needed for mirror-like effect or ESD, EMI shielding, thermal and electrically insulating materials or textiles for windows, homes, clothing, space suits, shelters, vehicles, and inflatable vehicles via reflection, a base material for audio or video magnetic recording tapes, solar and marine applications in sails or hulls, kites and parachutes, electronic/acoustic applications such as electrostatic loudspeakers dielectric in foil capacitors, and morphing materials for aircraft.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a flexible base material having at least one of shrinkable and stretchable properties; and
a flexible conductive material formed on the flexible base material, wherein:
the flexible conductive material comprises at least one nano-particle layer and at least one linking agent layer,
said at least one nano-particle layer is bonded to said at least one linking agent layer, and
the conducive material has at least one of shrinkable and stretchable properties.

2. The apparatus of claim 1, wherein the flexible base material comprises a shrinkable polymer.

3. The apparatus of claim 2, wherein the shrinkable polymer is polyvinyl chloride polyethylene terephthalate (PVC/PET).

4. The apparatus of claim 1, wherein the flexible base material has stretchable properties.

5. The apparatus of claim 4, wherein the stretchable properties allow the flexible base material to be strained by at least 1000% by at least one of mechanical, electrical, thermal, and light stimulus.

6. The apparatus of claim 1, wherein the flexible base material comprises a biaxially oriented polyethylene terephthalate material.

7. The apparatus of claim 1, wherein the flexible base material comprises a shape memory polymer.

8. The apparatus of claim 1, wherein said at least one nano-particle layer comprises conductive nano-size particles.

9. The apparatus of claim 8, wherein said conductive nano-size particles comprises gold nano-size particles.

10. The apparatus of claim 9, wherein said gold nano-size particles comprises gold clusters each having a diameter less than approximately 1000 nanometers.

11. The apparatus of claim 10, wherein said gold nano-size particles comprises gold clusters having a diameter less than approximately 50 nanometers.

12. The apparatus of claim 1, wherein:
said at least one nano-particle layer is bonded to said at least one linking agent layer by at least one of electrostatic bonding and covalent bonding; and
at least one of said at least one nano-particle layer and said at least one linking agent layer are bonded to the flexible base material by at least one of electrostatic bonding and covalent bonding.

13. The apparatus of claim 1, wherein:
said at least one linking agent layer is an elastomeric polymer;
individual particles of said at least one nano-particle layer are bonded to sites of the elastomeric polymer; and
at least one of individual particles of said at least one nano-particle layer and sites of the elastomeric polymer are bonded to sites of the flexible base material.

14. The apparatus of claim 1, wherein at least one of said at least one nano-particle layer, said at least one linking agent layer, and flexible base material is polarized.

15. The apparatus of claim 1, wherein the flexible base material is a shrinkable polymer, wherein the shrinkable polymer is shrunk after forming the conductive material on the flexible base material.

16. The apparatus of claim 14, wherein the shrinkable polymer is shrunk up to 500% by at least one of mechanical, electrical, thermal, and light stimulus.

17. The apparatus of claim 14, wherein the conductivity of the flexible conductive material increases after the shrinkable polymer is shrunk.

18. The apparatus of claim 1, wherein the flexible base material comprises at least one of:
PET;
PVC/PET;
polyurethane;
polysiloxane;
a poly(urethane-soloxane) copolymer;
poly(vinyl chloride);
polyisoprene-cis;
polyisobutylene;
polybutadiene;
styrene butadiene copolymers (SBR);
nitrile rubber;
an acrylonitrile-butadiene random copolymer;
butyl rubber;
an isoprene-isobutylene copolymer;
an acrylonitrile-butadiene-styrene copolymer;
polychloroprene; and
poly(ethylene-stat-propylene).

19. The apparatus of claim 1, comprising a polymer substrate functionalized with a chemical release layer, wherein the flexible base material is formed on the polymer substrate.

20. The apparatus of claim 1, wherein the flexible base material is mounted onto a frame during formation of the conductive material on the flexible base material.

21. A method of forming the apparatus of claim 1.
